(19) United States
(12) Patent Application Publication
(10) Pub. No.: US 2013/0239572 A1
(43) Pub. Date: Sep. 19, 2013

(54) DUAL ENERGY SOLAR THERMAL POWER PLANT

(71) Applicant: UV SOLAR POWER INC., LAS VEGAS, NV (US)

(72) Inventor: Chang Kuo, Las Vegas, NV (US)

(21) Appl. No.: 13/871,960

(22) Filed: Apr. 26, 2013

Related U.S. Application Data
(63) Continuation-in-part of application No. 13/251,937, filed on Oct. 3, 2011.

(51) Int. Cl. F03G 6/00

(52) U.S. Cl. CPC F03G 6/00
USPC 60/641.8

(57) ABSTRACT

A solar energy collector comprises a solid body having a substantially planar solar energy absorbing collecting surface. The solid body has a first thickness at a center portion tapering to a second thickness at each of a pair of opposing edge portions defining a width of the body. A bore extends completely through the body along its length and is aligned along an axis at the center portion. A window transparent at most solar radiation in the visible spectrum and near UV to infrared-red solar energy wavelengths is disposed at a distance from the collecting surface, the window sealed around a periphery of the collecting surface to define a sealed nitrogen filled gap between the collecting surface and the bottom surface of the window. The solar energy collector is a major component of a large scale solar thermal power plant.

This application is a continuation in part of inventor Chang Kuo's 13/251,937 Dual Energy Solar Power Plant, filed Oct. 18, 2011, the disclosure of which is incorporated herein by reference.

### BACKGROUND

1. Field of the Invention

The present invention relates to the design of dual source solar and thermal power generation. More particularly, the present invention relates to a design of power plant with solar collectors and associated thermal power generating equipment, utilizing the proposed particular solar energy collectors, and with the vacuum or nitrogen filled gas, auxiliary boiler/steam superheater and all thermal power generation supporting systems.

2. Discussion of Related Art

The amount of solar energy that falls on the surface of earth per minute is equivalent to burning 100,000,000 tons of coal per minute. The average solar energy per square cm on the earth's surface per minute is about 2 calories. This is equivalent to 4,423 BTU per square foot per day. The solar energy received on each individual area will be different depending on the cloud, moisture in atmosphere, dust in the air, location and season. For example, in the southwestern United States from Las Vegas to the Mexican border along the Colorado River, the solar energy per square foot is between about 1880 and about 2000 BTU per square foot per day. This area has over 300 sunny days per year. The area having the highest potential solar energy from Las Vegas and south to the Mexican border along the Colorado River encompasses approximately 60,000 square miles. Of that area, by estimation, approximately 20%, or about 12,000 square miles (about 7,680,000 acres), is useful for solar collection. The potential in this desert area could accommodate 200 or more 300 MW solar power plants. The total amount of power generated is sufficient to supply the power demands of the west coast and southwestern United States. With this kind of power potential, the building of new power transmission lines is justified.

With an estimation of only 60 more years of world oil supply, 80 more years of available nuclear fuel, 80 years of natural gas reserve and 300 more years of coal supply are left, the potential of the solar energy in this area should be actively developed. If this were to be done, there would be no need for building additional coal or nuclear power plants. This could save the world from the difficult problems of mining and refining the uranium for nuclear power fuel, treating and handling of unwanted spent nuclear fuel, reducing emission of additional CO₂, and mitigating the life and environment-threatening problem of global warming.

The development of solar power technology is a new trend in the industry. Many solar power projects have been planned and/or built with a large amount of investment. However, the results have been less than expected. The progress of solar power generation technology has been less than expected. The returns on invested capital are mostly lower than the original investment. At the present, the price of power generation by fossil fuel is lower than by solar power. Many solar power plants have been abandoned during construction, or after short-term operation. Generally, the bankers are hesitant to commit capital to solar power plant projects because the capital returns are less than anticipated. This is a disadvantage for human ambition to harness the solar power. The vast amount of solar energy has not been continuously utilized day after day. This invention is devised to overcome the hardship and gives a way to harness the solar energy effectively and practically until the technology is progressing to a point where more efficient and practical usage of solar power is real.

The photovoltaic solar power technology has gained considerable progress. It is now able to utilize 12 to 15 percent of incoming solar energy. Yet this is far below the 35% efficiency of a nuclear power plant, or 38% for a fossil power plant. The majority of the solar energy is not being used. Another shortcoming is that the power generated in this system is at low direct current (DC) voltage and is thus not suitable for long-distance transmission to electrical power users. The equipment cost of a photovoltaic solar power system would be too high for a large output, for example, the 300 mega-watts class power plant. The plant would be economically prohibitable and the rate of solar energy utilization is low. Worse, under strong bombardment of ultra-violet (UV) radiation, the high cost silicon solar panels deteriorate before the investment capital could be recovered. Therefore a large output photovoltaic power plant is not commercially practical. Many plants had been planned, built, and then abandoned. Those are the examples of failed economical activities.

The next choice is the solar thermal power plant. This is a steam turbine-generator power plant using a combination of solar energy collectors and a small auxiliary boiler/steam superheater. For a low temperature turbine set, a minimum steam temperature of 680° F. (360° C.) is required to drive the turbine. This is an object difficult to achieve by the proposed solar collector alone. See FIG. 5. An auxiliary boiler/steam superheater is included to supply additional heat on top of collected solar heat. This would guarantee a stable long-term turbine operation. This setup can also be used for power generation during cloudy or raining days.

The auxiliary boiler/steam superheater will require burning low amounts of natural gas to supply about 20% of the required heat, but the advantage is being able to harness large amounts of no cost solar power continuously.

With the rate of conversion of solar energy to electricity, it is estimated that an area of about 600 acres is required for a 300 MW solar power plant. Two hundred such plants would supply an output of 60,000 MW, enough to supply the total power needs of the entire west coast of the United States for example.

The three most important engineering considerations for a solar power generation plant are: (1) harvesting the solar energy, (2) preserving the harvested solar energy, and (3) utilizing it.

First, the necessary technical aspect is how to collect and absorb the solar energy efficiently; and the next is how to preserve the collected energy without losing it.

Finally, the collected and preserved solar energy should be able to be utilized to generate electrical power. In this invention, it is proposed to use the collected solar heat to heat the water or other heating medium to or near the required temperature level such that the final product, the heated steam, is sufficient to drive the turbine-generator set in a solar thermal power plant. The sufficient steam temperature to drive the turbine is estimated at about 680° F. (360° C.).

Other important considerations are the overall power plant cost and capability of long-term operation. It is necessary that the plant cost be reasonable and the plant is durable for long-term operation. Otherwise, it would not be practical for the capital investment. It would be unfeasible to build a solar thermal power plant if the equipment, labor and fuel costs are too high. There have been too many high capital solar power plants abandoned because of high cost, low efficiency, or short duration of effective operation time. The economy of the plant and the long-term effective operation are crucial to make the plant practical.

### BRIEF DESCRIPTION

A solar energy collector comprises a solid body having a substantially flat, planar solar energy absorbing collecting surface. The solid body has a first thickness at a center portion tapering to a second thickness at each of a pair of opposing edge portions defining a width of the body. A bore extends completely through the body along its length and is aligned along an axis at the center portion. A thin window transparent at selected solar energy wavelengths (for example, ultra violet solar radiation) is disposed at a distance from the collecting surface, the window sealed around a periphery of the collecting surface to define (1) a sealed vacuum gap between the collecting surface and the bottom surface of the window or (2) or nitrogen gas filled instead of a vacuum. The vacuum gap instead of air gap will prevent the heat conduction by air from the collecting surface to the bottom face of the window, as the oxygen in the air is highly heat conductive. The window glass thickness is to be 1/16 of an inch or less for maximum solar radiation transpierce effect. The normal glass of 1/16 of an inch six or thinner may not be able to withstand the pressure from the atmosphere; therefore the glass should be reinforced glass to resist against atmospheric pressure. Another way is to fill the gap by nitrogen gas instead of regular air. The advantage is that nitrogen will be able to resist the atmospheric pressure and in the nitrogen gas is more stable than oxygen against the temperature changes and less heat conductive since it is an inert gas.

In one exemplary embodiment, the first thickness at the center portion may be about 2.5 to about 3 inches, the second thickness at the opposing edges may be about 0.25 inch to about 0.5 inch, and the first thickness tapers to the second thickness substantially linearly. The bore hole may have a diameter of about 2 inches. The thicker central portion of the body is to provide higher heat sink and to provide sufficient space for the bore to be completely inside the body. Another effect is to provide sufficient mechanical strength to bear the pressure from high temperature water or liquid. The edges both being thin are for the purpose of lower cost by saving quantity of material.

The planar solar energy absorbing collecting surface is black in color, as the black color is the most efficient for absorbing solar energy among all colors in the visible light spectrum, and solar radiation with wavelengths between ultra-violet to infrared-red. The body may be formed using different techniques. One such technique is casting and another is extrusion. The body may be formed from a metal, such as aluminum, as the aluminum is highly heat conductive and low cost among other metal. In embodiments where the body is formed from aluminum, the planar solar energy absorbing collecting surface may be black anodized or may be painted black. The black anodized aluminum coating on the aluminum body offers the most efficient solar energy absorbing capability. The window may be formed from glass transparent at all energy carrying solar radiations with wavelengths between UV wavelength and infrared-red wavelength.

The solar energy collectors are lined up in many linear columns.

Water, propylene glycol or liquid salt can be used for heat transfer material in the solar collector.

When the water is heated to 212° F. (100° C.), it will start to boil and become steam. The steam volume will expand and pressure will increase in the pipe. This is not desirable during the preliminary heating process. One way to maintain the high temperature water in the liquid state is to add a pressurizer in the water piping system. It will make the water temperature and pressure high before turning the water to steam for use.

Although the use of auxiliary boiler/steam superheater in a dual sources solar power plant will burn a small amount of natural gas, making it not a 100% solar power plant, it is a question of being able to use 0% or 90% of solar energy. With the proposed solar collector, when ordinary insulation is used, the collector temperature could be brought up to 300° F. When vacuum technique is applied on the collector, the temperature will be brought up to 500 to 600° F. It still is lower than the required 680° F. In order to raise the temperature to 680° F. as required, natural gas heated boiler/steam superheater is needed, or the desired condition cannot be reached. The auxiliary boiler steam superheater is also required in the nitrogen filled solar heat collector.

The 680° F. steam is a difficult object to achieve by the proposed solar collector alone. See FIG. 5. An auxiliary boiler/steam superheater is included to supply additional heat on top of collected solar heat. This would guarantee a stable long-term turbine operation. This setup can also be used for power generation during cloudy or raining days.

Piping, pumps, heat exchangers, condensers, deaerators, valves, turbine-generator sets, water tanks, and water reserve pools are included in the plant facilities.

### BRIEF DESCRIPTION OF THE DRAWING FIGURES

FIG. 1A is a diagram showing a top view of an illustrative solar energy collector in accordance with one aspect of the present invention.

FIG. 1B is a cross-section view of the solar energy collector.

FIG. 2 is a diagram showing one way of mounting an illustrative solar energy collector in accordance with one aspect of the present invention.

FIG. 3 is a schematic diagram showing how the solar collector according to the present invention may be employed in a solar power generating plant in accordance with an aspect of the present invention. The shown solar collector is a simplified cross section view of a miles-long, solar collector line.

FIG. 4 is a diagram of plant arrangement showing an illustrative large-scale solar power generating plant in accordance with an aspect of the present invention.

FIG. 5 is a chart showing the different portions of heat coming from their respective heat sources, namely solar energy, the increased collector heat by employing vacuum technology to reduce the heat loss, and the heat added by the auxiliary boiler/steam superheater

The following call out list of elements references the elements of the drawings.
10: Solar Energy Collector
12: Body
14: Planar Solar Energy Absorbing Collecting Surface
16: Center Portion
18: Pair Of Opposing Edge Portions
20: Bore
22: Window
24: Sealed Vacuum Gap
26: Frame
28: Layer Of Insulation
30: Mounting Structures
32: Upright Support Members
34: Reference Numeral
36: Horizontal Support Member
38: Vertical Members
40: Solar-Driven Electrical Power Generating System
41: Pressurizer System
42: Heat Exchanger
44: First Coil
46: Heat Transfer Fluid Circulation Pump
48: Storage Tank
50: First Valve
52: Secondary Coil
54: Steam Superheater
56: Steam Section
58: Water Section
60: Burner Section
62: Steam Turbine
64: Electrical Generator
66: Condensate Pump
68: Condenser
70: Feed Pump
72: Deaerator
80: Solar Power Generating Plant
82: Array
84: Temperature Sensor
86: Second Valve
88: Third Valve
90: Heat Exchanger
91: Pressurizer
92: Circulating Pump
94: Fourth Valve
96: Fifth Valve
98: Heat Exchange Fluid Tank
100: Sixth Valve
104: Superheater
106: Turbine
108: Generator

### DETAILED DESCRIPTION

Persons of ordinary skill in the art will realize that the following description of the present invention is illustrative only and not in any way limiting. Other embodiments of the invention will readily suggest themselves to such skilled persons.

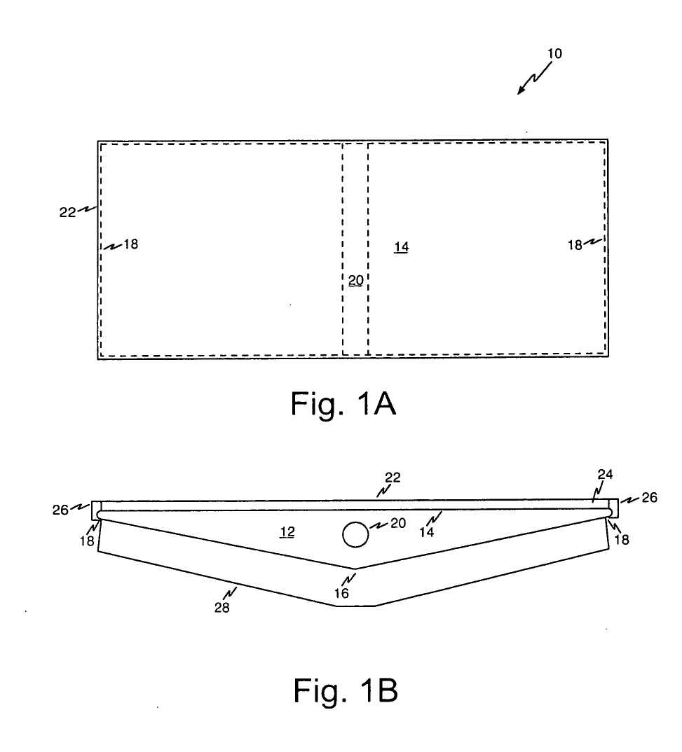

Referring first to FIGS. 1A and 1B, diagrams show top and cross-sectional views, respectively, of an illustrative solar energy collector 10 in accordance with one aspect of the present invention.

The solar energy collector 10 comprises a solid body 12 having a substantially flat planar solar energy absorbing collecting surface 14. The body 12 is formed from an efficient heat conductive material, yet the cost is low enough to make the power plant feasible. The planar solar energy absorbing collecting surface 14 should be configured to maximize energy absorption. In some embodiments of the invention, the collecting surface 14 is black in color. The body 12 may be formed from a metal, such as aluminum. The body 12 may be formed using different techniques. One such technique is extrusion, made possible if the body 12 is uniform in cross section along its entire length. Persons of ordinary skill in the art will appreciate that other techniques, such as casting, may be employed to form body 12. In embodiments where the body 12 is formed from aluminum, the planar solar energy absorbing collecting surface 14 may be black anodized or may be painted black with non-reflective or low-reflective paint to maximize energy absorption. The black anodized aluminum coating on the aluminum body offers high efficiency solar energy collection. A window 22 may be formed from glass transparent to the majority of solar radiation in the visible spectrum from near ultra-violet to infrared-red, comprising the major portion of the energy in sunlight.

In one exemplary embodiment, the first thickness at the center portion of the body 12 may be about 2.5 to about 3 inches, the second thickness at the opposing edges of the body 12 may be about 0.25 to about 0.5 inch. In one embodiment of the invention, the first thickness tapers to the second thickness substantially linearly. The thicker central portion of the body is to provide higher heat sink and to provide sufficient space for the bore to be completely inside the body. Another effect is to provide sufficient mechanical strength to bear the pressure from high temperature water or liquid in the bore. The thin both edges are for the purpose of lowering costs by saving quantity of material. The body 12 may be formed in lengths suitable for particular embodiments of a solar generating apparatus. In one embodiment, the body 12 may have a width of about 2 feet, and persons of ordinary skill in the art will appreciate that the length selected for any installation will be a function of practical considerations dictated by the particular application. In one embodiment a length of about 8 feet may be used, although persons of ordinary skill in the art will appreciate those considerations, such as collector weight, may affect the choice of length.

The solid body has a first thickness at a center portion 16 tapering to a second thickness at each of a pair of opposing edge portions 18 defining a width of the body. A bore 20 extends completely through the body along its length and is aligned along an axis at the center portion 16. In use, the bore 20 carries a heat-transfer fluid such as water, propylene glycol, liquid salt or other heat-transfer fluid used to transfer the collected heat to where it will be used.

The window 22 transparent for most energy carrying solar radiations with wavelengths between UV wavelength and infrared-red wavelengths is disposed at a distance, about ¼ inch, from the collecting surface 14. The window is formed from a material, such as a glass material, that is substantially transparent at most selected solar energy bandwidths. The window 22 is sealed around a periphery of the collecting surface to define a sealed vacuum gap 24 between the collecting surface 14 and the bottom surface of the window 22. In one particular embodiment, a window formed from a glass sheet having a thickness of about 1/16 inch or below shows most effective in passing solar energy bandwidths and traps heat inside the vacuum gap and prevents heat loss back to surrounding atmosphere due to air movement convection around the plate if the gap space is not vacuumed. The glass is a high density material compared to air. A glass with thickness higher than 1/16 inch would decrease the passing of solar radiation considerably, making it less effective. To resist against atmospheric pressure, reinforced glass may be required or the gap can be filled with substantially nitrogen gas instead of a vacuum. The window is enclosed in a frame 26. The frame is configured such that it is easily snapped onto the body 12 for replacement. The frame should also be insulated with a high grade of insulation material, preferably on or above 92% effective to prevent the heat loss to the surrounding air. This is preferable for raising the water or liquid temperature aiming at 680° F. level for performing power generation.

A layer of insulation 28 is disposed below the body 12 on the surface opposite the collecting surface 14 to prevent heat collected in the body 12 from being dissipated back into the ambient air. By preserving heat in the body 12, the layer of insulation 28 increases the temperature of the body 12 and increases the efficiency of heat transfer of the solar energy. The insulation material is high grade, preferably on or above 92% effective to prevent the heat loss to the surrounding air. This is necessary for raising the water or liquid temperature toward 680° F. level for performing power generation. The thickness of layer 28 will depend on its construction. Persons of ordinary skill in the art will appreciate that the composition of insulation 28 should be selected considering the conditions of the outdoor environment in which solar collector 10 will be employed, including, but not limited to, heat, solar radiation, wind, precipitation, etc. Numerous outdoor-rated insulating materials are available.

It is thought that the solar energy collector 12 in the form of a black painted aluminum body as disclosed in one embodiment of the invention will absorb 95% of the incoming solar energy. Hence, this is a particularly efficient solar energy harvest system. Aluminum has a high heat conductivity and low cost. It is extremely cost effective and makes the system practical.

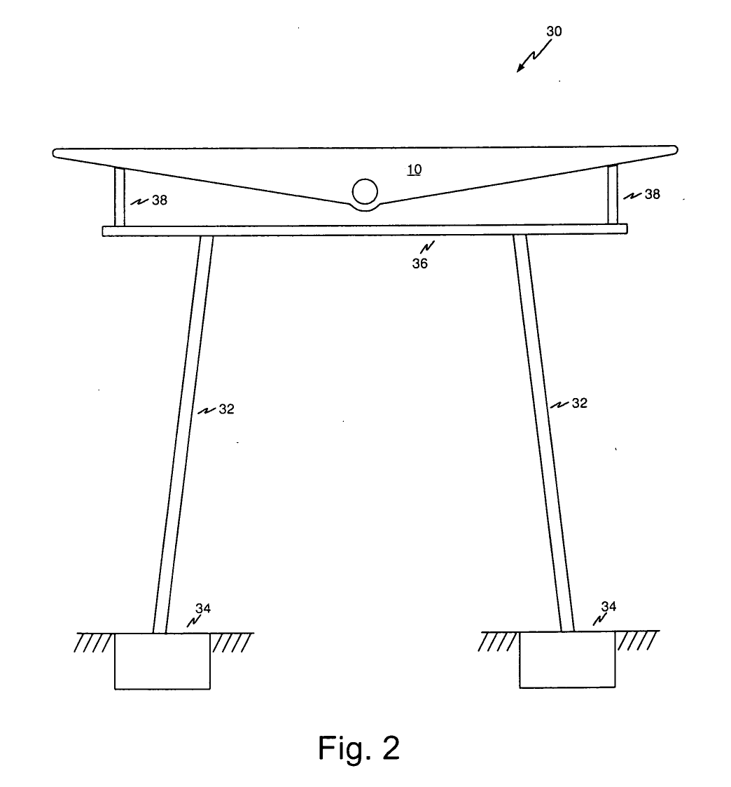

Referring now to FIG. 2, a diagram shows one illustrative way of mounting an illustrative solar energy collector 10 in accordance with an aspect of the present invention. The collector 10 is mounted on a mounting structure 30 or frame including upright support members 32. Support members 32 may be anchored in concrete as shown at reference numeral 34. A horizontal support member 36 is supported by upright supports 32. Vertical members 38 extend upward from horizontal support member 36 and support the lower surface of collector 10. Window 22 and insulating layer 28 are not shown in FIG. 2 to avoid overcomplicating the figure. Persons skilled in the art will appreciate that support members 32, 36, and 38 may be formed from a suitable material such as metal, and that a pair of mounting structures 30 may be utilized for each collector 10 in an array of such collectors. Although not necessary, the height of the support structure may be about 4 feet for easier access and ease in performing maintenance work.

Persons of ordinary skill in the art will appreciate that the solar energy collector 10 of FIG. 1 may also be movably mounted in a configuration that will allow it to track the solar movement in order to orient the planar solar energy absorbing collecting surface 14 as nearly normal to the direction of solar radiation as possible. Techniques and apparatus for enabling such tracking are well known in the art.

Persons of ordinary skill in the art will appreciate that the solar energy collector 10 of FIG. 1 may be used in a number of applications other than electrical power generation. Applications such as heating water for domestic use and for implementing solar hot-water domestic and commercial building heating systems are contemplated for the solar energy collector 10 of FIG. 1 in accordance with the present invention.

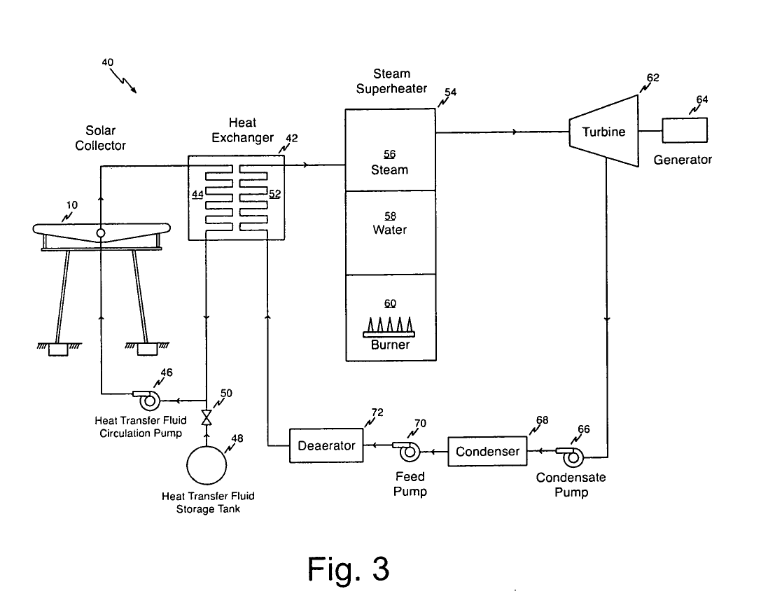

The solar collector 10 of FIG. 1 is most suitable for use in electrical power generation systems according to the present invention. Referring now to FIG. 3, a schematic diagram shows how the solar collector 10 according to the present invention may be employed as a component of a solar power generating plant in accordance with the present invention.

An illustrative solar-driven electrical power generating system 40 includes the solar collector 10. The shown solar collector 10 is a simplified cross section view of a long solar collector line. Persons of ordinary skill in the art will appreciate that a plurality of solar energy collectors 10 may be configured in series, by coupling together the bores 20 of an arbitrary number of solar energy collectors 10 using plumbing piping. Persons of ordinary skill in the art will appreciate that pipes used to connect solar energy collectors 10 to each other and to other components of the system to be described herein, would be covered by a layer of surrounding insulation in order to maximize efficiency by preventing unnecessary heat loss in the system.

The solar-driven electrical power generating system 40 includes a heat exchanger 42 that is used to transfer the heat from the heat-transfer fluid circulating in a primary loop that includes solar energy collectors 10, a first coil 44 in the heat exchanger 42, and a heat transfer fluid circulation pump 46. The heat-transfer fluid is under pressure in a closed system and thus may be allowed to reach temperatures in excess of its boiling temperature at atmospheric pressure. A pressurizer system 41 is required to maintain the liquid state under pressure due to high temperature. The heat-transfer fluid can reach temperatures in excess of about 680° F. (360° C.) before turning to steam. As previously noted, the heat-transfer fluid may be water, or another heat transfer fluid such as propylene glycol, liquid salt or the like. A storage tank 48 for providing make-up heat-transfer fluid is coupled to the primary loop through the first valve 50 to allow for compensating for loss of heat transfer fluid.

The heat exchanger 42 transfers the heat collected from the primary coil 44 to a secondary coil 52 through which water is circulated. The heated water is provided to steam a superheater 54 in which a steam section 56 provides superheated steam for driving the power plant. The steam superheater 54 is a low rating superheater that also includes a water section 58 and a burner section 60. The burner section 60 may be used to drive the power plant at night or during cloudy periods where the solar energy output of collector 10 is not sufficient to drive the system. In such case, it is used as the auxiliary boiler. The steam superheater is known in the art and their design is a matter of routine engineering.

Steam from the steam superheater 54 is fed to a steam turbine 62 that drives an electrical generator 64 to provide the electrical power output of the power plant 40. The exhausted steam is fed to condensate pump 66 and to a condenser 68 and through a feed pump 70 to a deaerator 72 as is known in the art. The output of the deaerator 72 is coupled to the secondary coil 52 in the heat exchanger 42 to complete the secondary loop.

The target efficiency for solar power utilization of the system of FIG. 3 is 50%. The anticipated power plant cost is less than 20% the cost of a traditional coal-fired power plant having the same electrical power output. Compared to a nuclear power plant, the cost of a solar power plant according to the present invention is less than 10% of a nuclear power plant if the fact that a coal power plant cost is less than half of a nuclear power plant having the same power output is considered. Because of many nuclear power regulatory requirements, the time required to build a solar power plant is much shorter than building a nuclear power plant. This is certainly a significant advantage. The saving on fuel cost is another advantage.

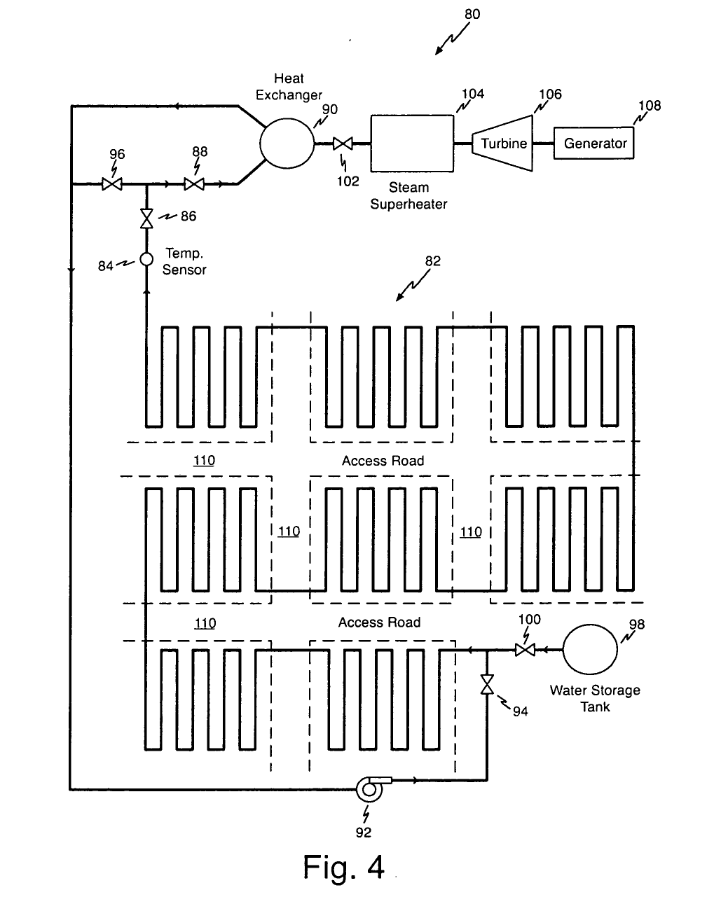

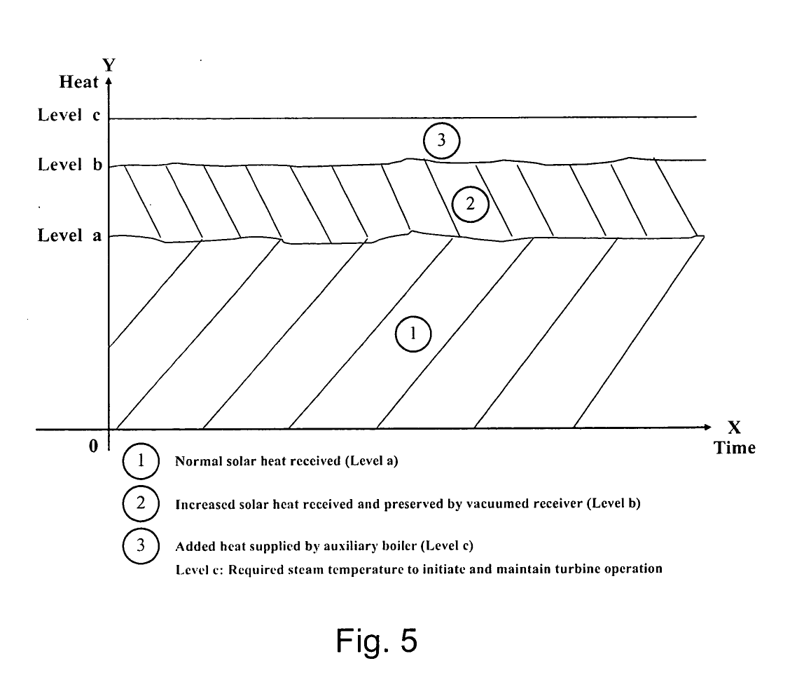

Referring now to FIG. 4, a diagram of plant arrangement shows another way of an illustrative large-scale solar power generating plant 80 in accordance with the present invention.

The solar power generating plant 80 shown in FIG. 4 includes an array 82 of solar energy collectors 10 of FIG. 1. The solar energy collectors 10 may be disposed in a continuous line except for turns at the edges. As previously noted, the height may be about 4 feet for easier access and ease in performing maintenance work.

In order to generate electrical power in the range of 300 megawatts (MW), the total surface area of the collecting surfaces 14 in array 82 should be about 300 acres. The total area required for the complete power plant in a typical installation would be about 600 acres.

A primary loop in the solar power generating plant 80 includes an array 82, temperature sensor 84, the second valve 86, the third valve 88, a primary coil (not shown) in a heat exchanger 90, a pressurizer 91, a circulating pump 92 and the fourth valve 94. Upon system startup, and thereafter, whenever the temperature sensor 84 indicates that the temperature of the heat-exchange fluid from the array 82 is less than a setpoint temperature, the third valve 88 is closed and the fifth valve 96 is opened, allowing the heat-exchange fluid to circulate in the array 82 until the desired setpoint temperature is reached, at which time the third valve 88 is opened and the fifth valve 96 is closed. A heat-exchange fluid tank 98 is used to provide replenishment of lost heat-exchange fluid as desired through the sixth valve 100. The function of the pressurizer is to maintain the water or liquid in liquid state when the temperature is above boiling point.

During system operation, the secondary coil (not shown) of the heat exchanger 90 provides the steam to steam a superheater 104, which operates in the manner described for the steam superheater 54 of FIG. 3. The steam is used to drive a turbine 106, which, in turn, drives a generator 108. The steam superheater is also used as the auxiliary boiler.

Using 300 acres as the effective solar energy collecting area, the entire plant site may be approximately 600 acres. Required cooling water for a 300 MW plant is about 3,600 gallons per minute, but the water can be recycled. A water pool may be provided for storing reserved water.

The amount of coal required in a 300 MW coal power plant is about 150 tons per hour. For a 10-hour operating day, such a plant consumes about 1,500 tons per day. At a cost of $50 per ton, the daily coal cost is about $75,000 per day, and the annual coal cost is about $27,375,000. Therefore, the saving on the cost of coal used in a 300 MW plant=90%=$24,637,500 per year, estimating that 10% of the currently-used natural gas would be consumed. Using this assumption leads to a reduction of CO₂ in the atmosphere=90%×1,500 ton×365 days=492,750 tons per year for a 300 MW plant.

While embodiments and applications of this invention have been shown and described, it would be apparent to those skilled in the art that many more modifications than mentioned above are possible without departing from the inventive concepts herein. The invention, therefore, is not to be restricted except in the spirit of the appended claims. For example, a pressure relief valve can be added before and after the heat exchanger 90.

1. A solar energy collector comprising:
a. a solid body having a length, having a flat planar solar energy absorbing collecting surface, the solid body having a first thickness at a center portion tapering to a second thickness at each of a pair of opposing edge portions defining a width of the body, the second thickness being less than the first thickness;
b. a bore extending completely through and inside the body along its length and aligned along an axis at the center portion, wherein the bore is watertight to avoid leaking of heat transfer liquid through the bore which is disposed through the solid body;
c. a glass window transparent at solar energy wavelengths disposed at a distance from the collecting surface, the window sealed around a periphery of the collecting surface to define sealed space gap between the collecting surface and the bottom surface of the window, wherein the space gap is a nitrogen filled space to minimize heat transfer from the bottom surface to the window glass, thereby minimizing heat dissipation from the glass surface to the atmosphere.

2. The solar energy collector of claim 1, wherein the solar energy collector is a thermal power plant of a size of less than a maximum of 300 MW (megawatt) built on a land of 600 acres where the average summer sunlight has 1880 BTU per square foot per minute or above.

3. The solar energy collector of claim 1, wherein the flat planar solar energy absorbing collecting surface is black in color either by painting or by anodized aluminum coating.

4. The solar energy collector of claim 1, wherein the solar energy collector body is formed as an extrusion or casting.

5. The solar energy collector of claim 1, wherein the solar energy collector body is formed from a metal aluminum.

6. The solar energy collector of claim 1, wherein the window is formed from glass transparent for UV wavelengths and other sunlight wavelengths with energy.

7. The solar energy collector of claim 1, wherein the thickness of the window glass is at a maximum of 1/16 of an inch, and can be thinner to maximize the passage of sunlight;

8. The solar energy collector of claim 1, the first thickness at the center portion is between about 2.5 inches and about 3 inches.

9. The solar energy collector of claim 1, wherein the second thickness at the opposing edges is between about 0.25 inches and about 0.5 inches.

10. The solar energy collector of claim 1, wherein the first thickness tapers to the second thickness substantially linearly.

11. The solar energy collector of claim 1, wherein the space between the glass and the bottom heat collector aluminum plate is of vacuum, and the space is limited at ¼ inch for best energy absorbing effect.

12. The solar energy collector of claim 1, wherein the solar energy collector body is sealed at three surfaces with high efficiency insulation material except at the top of glass window, wherein the insulation material has an insulation efficiency of 92 percent minimum.

13. The solar energy collector of claim 1, wherein the solar energy collector is formed as a solar thermal power plant system and further includes: a solar energy collector, insulated piping system, water pump system, heat exchangers, pressurizer, auxiliary boiler/steam superheater, deaerator, condenser system, and turbine generator system.

14. The solar energy collector of claim 13, wherein the first thickness at the center portion is between about 2.5 inches and about 3 inches.

15. The solar energy collector of claim 13, wherein the second thickness at the opposing edges is between about 0.25 inches and about 0.5 inches.

16. The solar energy collector of claim 13, wherein the first thickness tapers to the second thickness substantially linearly.

17. The solar energy collector of claim 13, wherein the space between the glass and the bottom heat collector aluminum plate is of vacuum, and the space is limited at ¼ inch for best energy absorbing effect.

18. The solar energy collector of claim 13, wherein the solar energy collector is a thermal power plant of a size of less than a maximum of 300 MW (megawatt) built on a land of 600 acres where the average summer sunlight has 1880 BTU per square foot per minute or above; wherein the flat planar solar energy absorbing collecting surface is black in color either by painting or by anodized aluminum coating; wherein the solar energy collector body is formed as an extrusion or casting; wherein the solar energy collector body is formed from a metal aluminum; wherein the window is formed from glass transparent for UV wavelengths and other sunlight wavelengths with energy; wherein the thickness of the window glass is at a maximum of 1/16 of an inch, and can be thinner to maximize the passage of sunlight; wherein the first thickness at the center portion is between about 2.5 inches and about 3 inches; wherein the second thickness at the opposing edges is between about 0.25 inches and about 0.5 inches; wherein the first thickness tapers to the second thickness substantially linearly; wherein the space between the glass and the bottom heat collector aluminum plate is of vacuum, and the space is limited at ¼ inch for best energy absorbing effect; wherein the solar energy collector body is sealed at three surfaces with high efficiency insulation material except at the top of glass window, wherein the insulation material has an insulation efficiency of 92 percent minimum.
